(19) United States
(12) Patent Application Publication
(10) Pub. No.: US 2011/0272083 A1
(43) Pub. Date: Nov. 10, 2011

(54) Glove Finger Cap and Method of Installing Same

(76) Inventor: Paul C. Yatkowski, Scottsdale, AZ (US)

(21) Appl. No.: 13/096,517

(22) Filed: Apr. 28, 2011

Related U.S. Application Data
(60) Provisional application No. 61/332,122, filed on May 6, 2010.

(51) Int. Cl. B32B 43/00; B32B 37/10; B32B 38/00; B32B 37/12

(52) U.S. Cl. 156/94; 156/349

(57) ABSTRACT

A glove patch system for a finger of a glove includes a tubular cap and an adhesive. A method of installing the tubular cap onto the glove finger includes partially turning the tubular cap inside out to form a pocket on a closed end of the tubular cap. The adhesive is applied to at least a portion of the glove finger. The pocket of the cap is positioned over the adhesive applied to a fingertip of the glove finger, and pressure is applied to adhere an inner surface of the tubular cap within the pocket of the cap to the glove finger. The tubular cap is unrolled down a length of the glove finger to adhere a remainder of the inner surface of the tubular cap to the glove finger using the adhesive.

### RELATED INVENTION

The present invention claims priority under 35 U.S.C. §119(e) to: “Glove Finger Cover and Installation Method Therefore,” U.S. Provisional Application Ser. No. 61/332,122, filed 6 May 2010, which is incorporated by reference herein.

### TECHNICAL FIELD OF THE INVENTION

The present invention relates generally to a glove patch system. More specifically, the present invention relates to a method of installing a glove finger cap on a finger of a glove.

### BACKGROUND OF THE INVENTION

Gloves are utilized for a multitude of purposes both in work environments and in recreational environments. Gloves protect and comfort hands against cold or heat, damage by friction, abrasion or chemicals, and disease; or in turn provide a guard for what a bare hand should not touch.

Gloves can become torn, frayed, or otherwise worn when subjected to use. A torn glove can be costly and/or inconvenient to replace. Consequently, a user of a glove may attempt to repair a tear in his or her glove by sewing the tear closed, by wrapping the torn portion of the glove in tape, and so forth. Unfortunately, these repair techniques are typically short-lived. For example, the stitches of a sewn glove may tear or let loose, or tape may not adequately remain adhered to the glove in a wet environment.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a perspective view of a glove patch system in accordance with an embodiment;

FIG. 2 shows a top view of a first fabric portion used to form a tubular cap of the glove patch system;

FIG. 3 shows a top view of a second fabric portion used to form the tubular cap;

FIG. 4 shows a top view of the first and second fabric portions coupled together;

FIG. 5 shows a perspective view of the tubular cap of the glove patch system turned inside out;

FIG. 6 shows a side view of the tubular cap partially turned inside out to form a pocket;

FIG. 7 shows a front view of a glove worn by a user and being prepared for installation of the tubular cap;

FIG. 8 shows a front view of the glove in which the tubular cap is positioned on a glove finger;

FIG. 9 shows a front view of the glove with adhesive applied to an intermediate section of the glove finger;

FIG. 10 shows a front view of the glove in which an applicator is utilized to unroll the tubular cap;

FIG. 11 shows a front view of the glove with adhesive applied to a proximal end of the glove finger; and

FIG. 12 shows a back view of the glove following installation of the tubular cap onto the glove finger.

### DETAILED DESCRIPTION

Gloves are often utilized for winter activities, such as for skiing, snowboarding, and other general use activities. Such gloves are used to protect a user's hands from injury during the aforementioned winter activities, as well as to protect them from cold temperatures and/or wet conditions. Unfortunately, the gloves can become worn, frayed, or torn. For example, glove fingertips can be subjected to significant abrasion when performing certain maneuvers on a snowboard. The wearing, fraying, and/or tearing in the tips of the glove fingers is particularly problematic because the extremities, such as a user's fingertips, tend to get cold faster than other portions of the body. Thus, a winter activity enthusiast may be compelled to suffer some cold fingertip discomfort and/or discontinue their winter activity before they wish to do so because of fingers that have become too cold. Alternatively, a user may be compelled to purchase replacement gloves. Unfortunately, gloves are costly to replace, and glove users are adverse to replacing them when only the glove fingertips are worn.

Accordingly, an embodiment of the invention entails a glove patch system that includes a tubular cap that replicates the shape of a glove finger of a glove. Another embodiment of the invention entails a method of installing the tubular cap of the glove patch system onto a glove finger so that the tubular cap is suitably positioned and securely coupled to the glove finger. A tubular cap may be installed over each of the fingers of ski and snowboarding gloves prior to their becoming worn, frayed, or torn to provide reinforcement, thus preventing the wear and tear that can damage even high quality gloves. Alternatively, should a finger tip of a glove become damaged, the tubular cap may be installed over the damaged region of the glove finger to repair it. Such a system and methodology can achieve significant cost savings by extending the life of the gloves.

Furthermore, the tubular cap may be customized by adding a particular logo, name, graphic image, sports symbol, and the like. Such customization enables the user to create an identity or express themselves through an article of apparel, namely the user's gloves (by the installation of the customized tubular cap), that heretofore has not been customizable. More importantly, when one or more customized tubular caps are installed onto the glove fingers, a user can more readily distinguish or identify his or her gloves when winter gear is piled up in a stack, on a shelf, in a basket, and so forth. Problems associated with lost or misplaced gloves, stolen gloves, mistaken identity, and the like are reduced because a user can more readily identify his or her gloves.

Embodiments of the invention are described below in connection with a glove used for winter activities such as skiing or snowboarding. However, it should be understood that embodiments of the invention may be readily adapted for gloves that are used for a multitude of purposes to reinforce and/or repair the gloves.

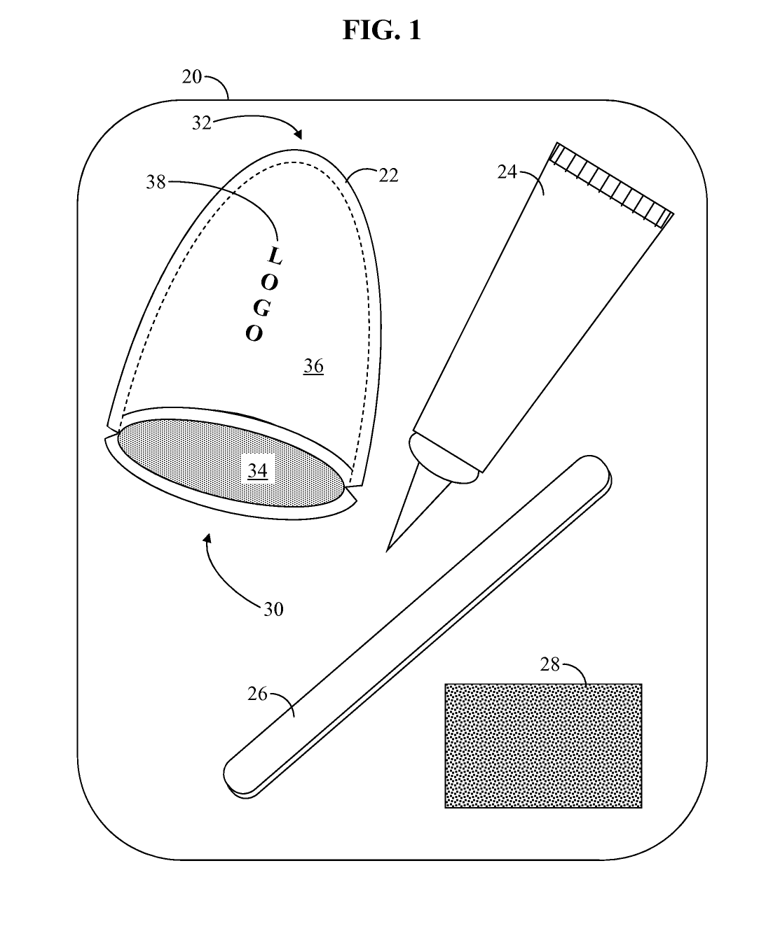

FIG. 1 shows a perspective view of a glove patch system 20 in accordance with an embodiment. In an embodiment, glove patch system 20 includes a tubular cap 22, an adhesive 24, an applicator 26, and an abrasive material 28. The components of glove patch system 20 may be provided in an easily transportable kit form along with instructions for use.

Accordingly, a user can install tubular cap 22 at home or at, for example, a ski resort, when one or more worn or damaged glove fingers are discovered. As will be discussed in detail below, tubular cap 22 is installed onto a glove finger of a glove using adhesive 24, applicator 26, and abrasive material 28 to facilitate the installation.

Those skilled in the art will readily recognize that glove patch system 20 need not include all of the components mentioned above. For example, glove patch system 20 may include tubular cap 22 and adhesive 24, while the user supplies applicator 26 and abrasive material 20. Alternatively, glove patch system 20 may include multiple components, such as multiple tubular caps 22 that fit multiple glove fingers.

In general, tubular cap 22 has an open end 30, a closed end 32, an inner surface 34, and an outer surface 36. An image 38, such as a logo, name, graphic image, sports symbol, and the like may be imprinted on outer surface 36. Tubular cap 22 is preferably formed from a textile material that replicates a material used to form a glove. Such textile materials include, for example, nylon, leather, Gore-Tex, polyester, and so forth. Tubular cap 22 is further formed to a specific size and shape that replicates the shape of a glove finger. The shape, size, and material of tubular cap 22 can be customized to the specific model, style, type, and material of the glove that tubular cap 22 is to be used on.

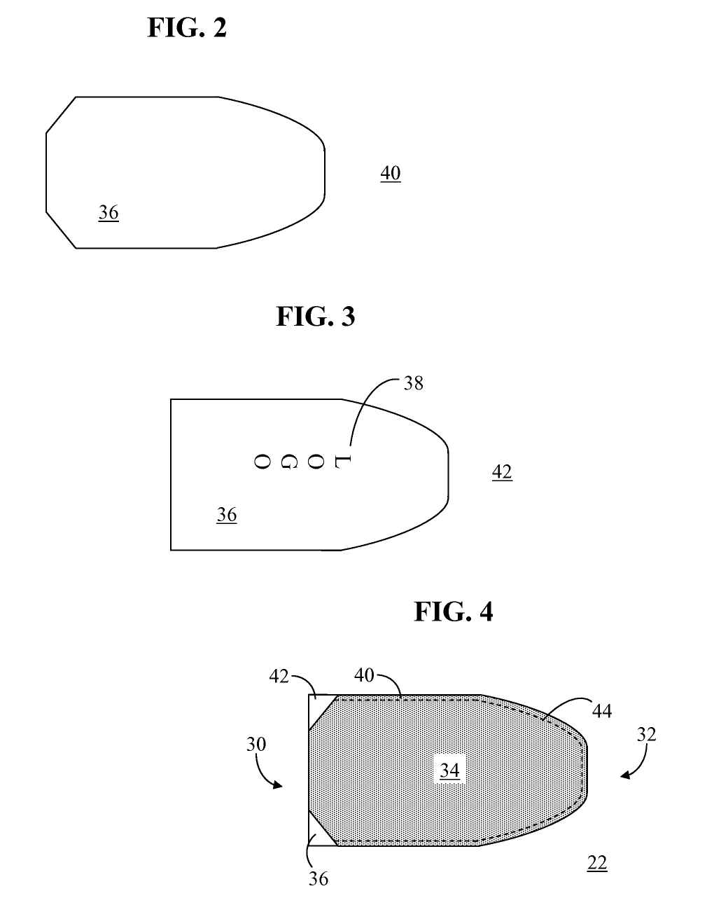

Referring to FIGS. 2-4, FIG. 2 shows a top view of a first fabric portion 40 used to form tubular cap 22 (FIG. 1) of glove patch system 20 (FIG. 1). FIG. 3 shows a top view of a second fabric portion 42 used to form tubular cap 22, and FIG. 4 shows a top view of first and second fabric portions 40 and 42, respectively, coupled together to form tubular cap 22.

First fabric portion 40 serves as the “inside” of tubular cap 22, i.e., the side of tubular cap 22 that when installed is arranged on the palm side of the glove. Whereas, second fabric portion 42 serves as the “outside” of tubular cap 22, i.e., the side of tubular cap 22 that when installed is arranged on the back side of the glove. Second fabric portion 42 is illustrated with image 38 imprinted on its outer surface 36. However, in alternative embodiments, image 38 may be imprinted on outer surface 36 of first fabric portion 40. And in still another embodiment, images 38 may be imprinted on outer surfaces 36 of both first fabric portion 40 and second fabric portion 42.

In FIG. 4, first and second fabric portions 40 and 42 are coupled together with their respective outer surfaces 36 facing one another, and their respective inner surfaces 34 facing outward. In such a manner, a periphery of first and second fabric portions 40 and 42, excluding open end 30 may be sewn, glued, or otherwise secured together. In the illustrated embodiment, first and second fabric portions 40 and 42 are sewn on three sides to yield closed end 32 and the tubular configuration of tubular cap 22. A seam 44 is represented by dashed lines about the three sides of first and second fabric portions 40 and 42. After first and second fabric portions 40 and 42 are coupled together, tubular cap 22 may be turned right side out so that outer surfaces 36 are facing outward, as shown in FIG. 1. Tubular cap 22 can subsequently be packaged with adhesive 24, applicator 26, and abrasive material 28 to form glove patch system 20 (FIG. 1).

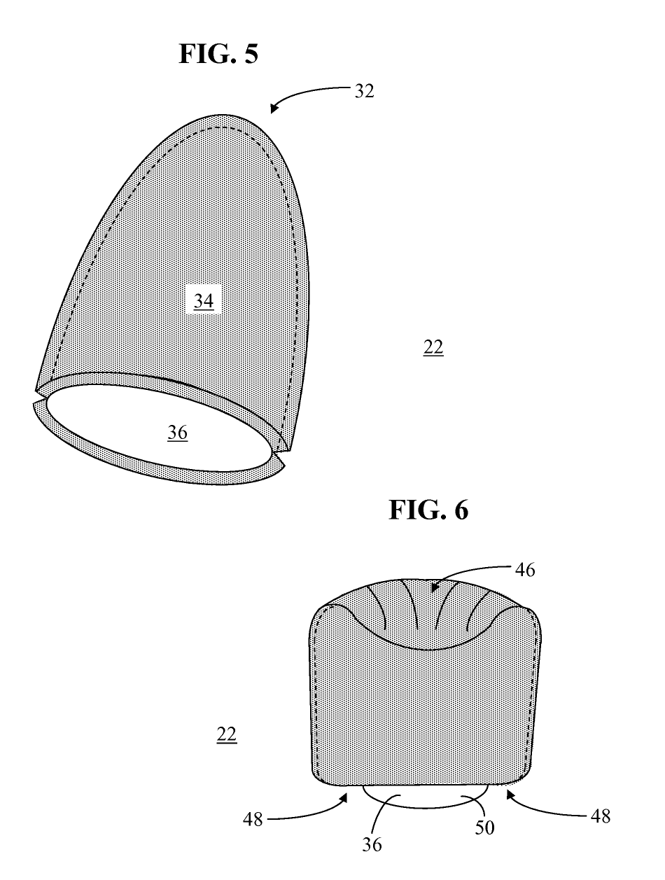

FIGS. 5-12 illustrate the various operations of a method of installing tubular cap 22 on a glove finger of a glove using glove patch system 20 so that tubular cap 22 is suitably positioned and securely coupled to the glove finger.

FIG. 5 shows a perspective view of tubular cap 22 of the glove patch system 20 (FIG. 1) turned inside out. In such a configuration, inner surface 34 of tubular cap 22 is facing outwardly, and outer surface 36 of tubular cap is facing inwardly.

FIG. 6 shows a side view of tubular cap 22 partially turned inside out to form a pocket 46. Pocket 46 may be formed by pushing closed end 32 (see FIG. 5) inwardly by, for example, approximately one inch. This action causes a portion 48 of outer surface 36 of tubular cap 22 to fold back and face another portion 50 of outer surface 36 of tubular cap 22.

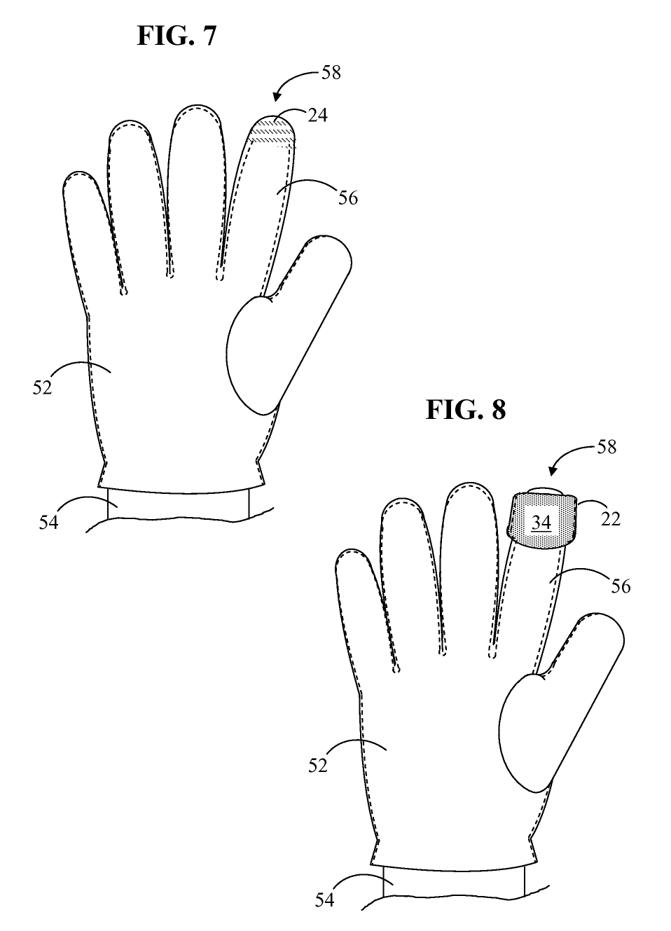

FIG. 7 shows a front view of a glove 52 worn by a user 54 and being prepared for installation of tubular cap 22 (FIG. 1). In this illustration, the front view of glove 52 constitutes the palm side of glove 52 when it is worn by user 54. In an embodiment, tubular cap 22 is installed on a glove finger 56 of glove 52 while glove is worn on the hand of user 54. Although methodology is described herein for installing only one tubular cap 22, it should be understood that user 54 may wish to concurrently install multiple tubular caps 22 on multiple glove fingers 56 of glove 52.

In order to prepare glove finger 56 for installation of tubular cap 22, the entire glove finger 56 is initially roughened by abrading it with abrasive material 28 (FIG. 1) supplied in glove patch system 20 (FIG. 1). Next, adhesive 24 (FIG. 1) is applied to a distal end 58, i.e., the finger tip, of glove finger 56. In an example, adhesive 24 may be applied to cover approximately one inch of distal end 58 of glove finger 56.

FIG. 8 shows a front view of glove 52 in which the tubular cap 26 is positioned on distal end 58 of glove finger 56. Methodology entails positioning pocket 46 (FIG. 6) of tubular cap 22 over adhesive 24 (FIG. 7) applied to distal end 58 of glove finger 56. The indentation, i.e., pocket 46, is firmly pressed over glove finger 56 so that inner surface 34 of tubular cap 22 in pocket 46 contacts adhesive 24. Pressure is applied until adhesive 24 sets and inner surface 34 of tubular cap 22 is adhered in place.

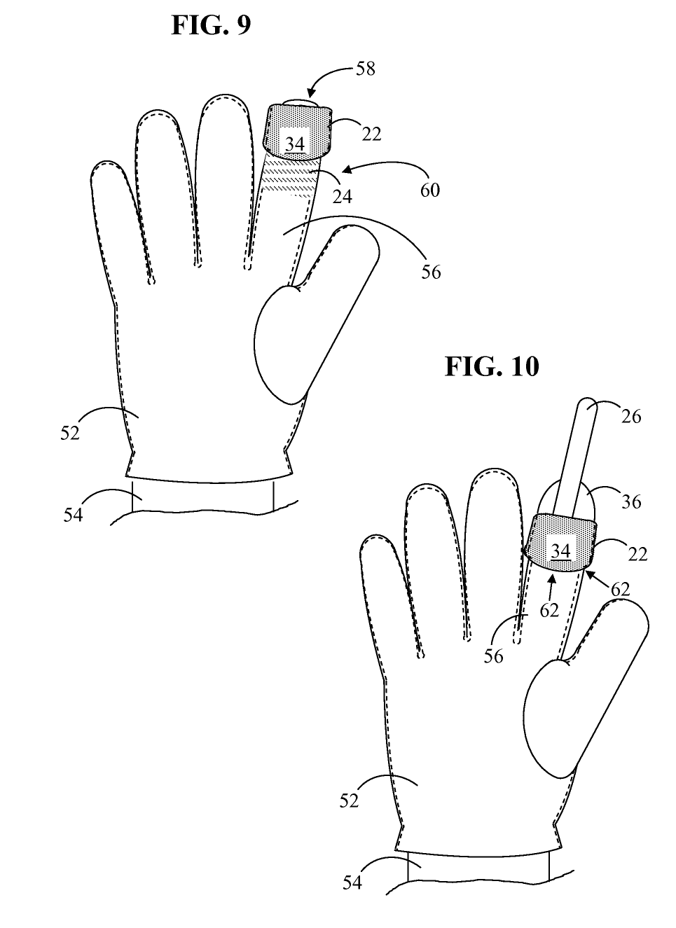

FIG. 9 shows a front view of glove 52 with adhesive 24 applied to an intermediate section 60 of glove finger 56. Once tubular cap 22 is adhered to distal end 58 of glove finger 56, adhesive 24 can be generously applied to intermediate section 60, i.e., the middle portion, of glove finger 56. In addition, or alternatively, adhesive 24 may be applied to inner surface 34 of tubular cap 22 that will next be rolled onto glove finger 56.

FIG. 10 shows a front view of glove 52 in which applicator 26 is utilized to unroll tubular cap 22. Applicator 26 provided in glove patch system 20 may be utilized to facilitate smooth unrolling of tubular cap 22. More particularly, applicator 26 can be slid between facing portions 48 and 50, respectively (FIG. 6), of outer surface 36 of tubular cap 22 to apply pressure or force against tubular cap 22 at a fold junction 62 between facing portions 48 and 50. Tubular cap 22 is unrolled down intermediate section 60 of glove finger 56 to cover the previously applied adhesive 24 (FIG. 9).

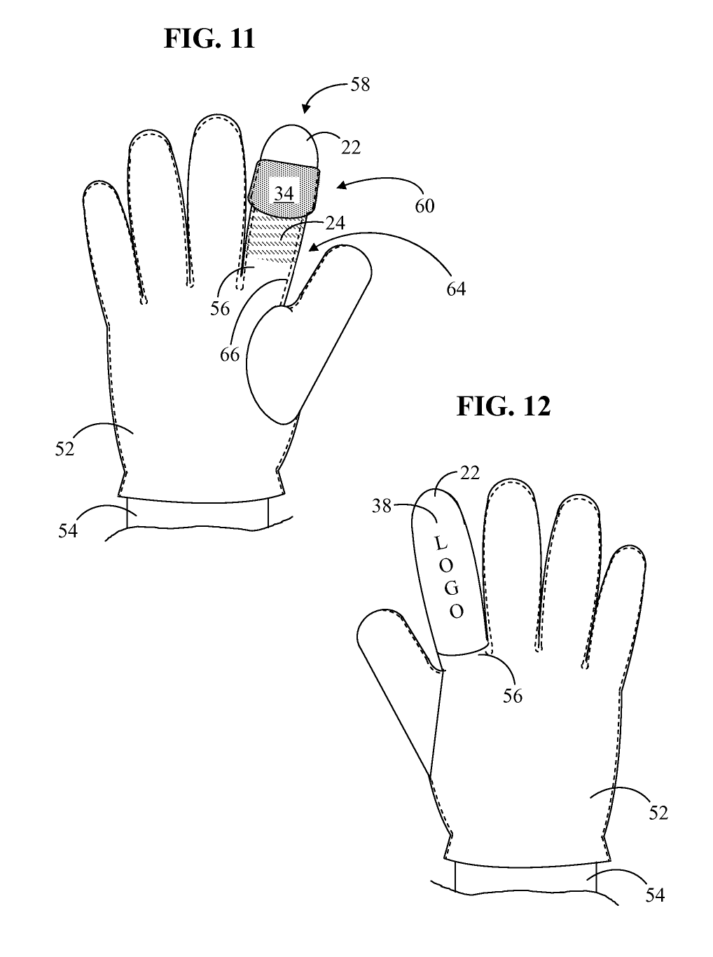

FIG. 11 shows a front view of glove 52 with adhesive 24 applied to a proximal end 64 of glove finger 56. Once tubular cap 22 is adhered to intermediate section 60 of glove finger 56, adhesive 24 can be generously applied to proximal end 64, i.e., the base, of glove finger 56. Thus, adhesive 24 is applied to the remaining length of glove finger 56. In addition, or alternatively, adhesive 24 may be applied to inner surface 34 of tubular cap 22 that will next be rolled onto glove finger 56.

Applicator 26 provided in glove patch system 20 can then be utilized to finish unrolling tubular cap 22 until tubular cover is completely unrolled and glove finger 56 is fully enveloped by glove finger 56. Next, tubular cap 22 may be manually manipulated to align seams 44 (FIG. 4) of tubular cap 22 with seams 66 (represented by dashed lines) on opposing sides of a length of glove finger 56. Once alignment is complete and with the hand of user 54 still in glove 52, the covered glove finger 56 is firmly gripped with the user's other hand. User 54 can then apply pressure by squeezing the covered glove finger 56 to facilitate adhesion of tubular cap 22 onto glove finger 56.

FIG. 12 shows a back view of glove 52 following installation of tubular cap 22 onto glove finger 56. In this illustration, the back view of glove 52 constitutes the back side of glove 52 when it is worn by user 54. As shown, tubular cap 22 reinforces and protects an entire length of glove finger 56. Additionally, as shown, image 38 is visible on glove finger 56 to add a distinguishing feature to glove 52. Once tubular cap 22 is adhered to glove finger 56, glove 52 may be removed and placed in an undisturbed location for a period of time so that adhesive 24 can firmly and completely set.

In summary, the present invention entails a glove patch system that includes a tubular cap that replicates the shape and material properties of a glove finger of a glove. Another embodiment of the invention entails a method of installing the tubular cap of the glove patch system onto a glove finger so that the tubular cap is suitably positioned and securely coupled to the glove finger using an adhesive. The tubular cap may be installed over glove fingers to provide reinforcement, thus preventing the wear and tear that can damage even high quality gloves, and/or to repair a glove finger. Such a system and methodology can achieve significant cost savings by extending the life of the gloves. Additionally, the tubular cap may be customized with a particular image so that a user can more readily identify his or her gloves thereby mitigating problems with lost gloves, mistaken identity, and the like.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A method of installing a tubular cap on a glove finger of a glove, said tubular cap having an open end, a closed end, an inner surface, and an outer surface, and said method comprising:
partially turning said tubular cap inside out to form a pocket at said closed end;
applying an adhesive to said glove finger;
positioning said pocket of said tubular cap over said adhesive applied to said glove finger to adhere said inner surface within said pocket of said tubular cap to said glove finger; and
unrolling said tubular cap down a length of said glove finger to adhere a remainder of said inner surface of said tubular cap to said glove finger.

2. A method as claimed in claim 1 further comprising abrading said glove finger with an abrasive material prior to applying said adhesive to said glove finger.

3. A method as claimed in claim 1 wherein:
said turning operation exposes a portion of said inner surface of said tubular cap;
said applying operation comprises applying said adhesive to a distal tip portion of said glove finger without applying said adhesive to said length of said glove finger;
said positioning operation comprises initially unrolling said tubular cap to cover said adhesive on said glove finger without covering said length of said glove finger;
following said positioning operation, applying an additional portion of said adhesive to at least one of said length of said glove finger and said exposed portion of said inner surface of said tubular cap; and
performing said unrolling operation to adhere said inner surface of said tubular cap to said length of said glove finger.

4. A method as claimed in claim 3 wherein:
said applying said additional portion of said adhesive comprises applying said additional portion of said adhesive to an intermediate section of said glove finger between said distal end and a proximal end of said glove finger without applying said adhesive to said proximal end of said glove finger;
said performing operation comprises performing said unrolling operation to cover said adhesive in said intermediate section said glove finger without covering a remainder of said length of said glove finger;
applying another portion of said adhesive to said proximal end of said glove finger; and
continuing said unrolling operation to cover said adhesive in said proximal section of said glove finger.

5. A method as claimed in claim 1 wherein said turning said tubular cap inside out causes a first portion of said outer surface of said tubular cap to fold back and face a second portion of said outer surface of said tubular cap, and said unrolling operation comprises:
sliding a rigid applicator between said first and second portions of said outer surface; and
utilizing said rigid applicator to apply pressure against said tubular cap at a fold junction between said first and second portions to unroll said tubular cap.

6. A method as claimed in claim 1 wherein said glove finger includes glove seams on opposing sides of said glove finger and aligned with said length of said glove finger, said tubular cap includes cap seams on opposing sides of said tubular cap and aligned with a length of said tubular cap, and said method further comprises aligning said cap seams with said glove seams.

7. A method as claimed in claim 1 further comprising:
installing said glove on a hand of a user; and
performing said applying, positioning, and unrolling operations while said glove is worn on said hand of said user.

8. A method as claimed in claim 7 further comprising compressing said tubular cap on said glove finger while said glove is worn on said hand of said user following said unrolling operation.

9. A method as claimed in claim 1 wherein said tubular cap replicates at least one of a shape of said glove finger and a material used to form said glove finger.

10. A method as claimed in claim 1 wherein said glove is utilized for winter activities, and said tubular cap is utilized to perform at least one of reinforcing said glove finger and repairing a damaged area in said glove finger.

11. A glove patch system for a glove finger of a glove worn on a hand of a user comprising:
a tubular cap having an open end, a closed end, an inner surface, and an outer surface, said tubular cap being formed from a textile material that replicates a material used to form said glove finger, and said tubular cap replicating a shape of said glove finger, said tubular cap being adapted to at least partially turn inside out to form a pocket at said closed end; and
an adhesive adapted to be applied to said glove finger, said tubular cap configured to be installed on said glove finger with said pocket positioned over and said inner surface attached to said adhesive, and said tubular cap being further configured to be unrolled down a length of said glove finger to adhere a remainder of said inner surface of said tubular cap to said glove finger.

12. A glove patch system as claimed in claim 11 further comprising an abrasive material adapted for use in abrading said glove finger prior to applying said adhesive to said glove finger.

13. A glove patch system as claimed in claim 11 wherein when said tubular cap is at least partially turned inside out, a first portion of said outer surface folds back and faces a second portion of said outer surface, and said system further comprises a rigid applicator, said rigid applicator being adapted to slide between first and second portions of said outer surface, and said rigid applicator being further adapted to be utilized to apply pressure against said tubular cap at a fold junction between said first and second portions to unroll said tubular cap.

14. A glove patch system as claimed in claim 11 wherein said outer surface of said tubular cap includes a distinct graphic image imprinted thereon.

15. A method of installing a tubular cap to a glove finger of a glove, said tubular cap having an open end, a closed end, an inner surface, and an outer surface, and said method comprising:
partially turning said tubular cap inside out to form a pocket at said closed end, said turning operation exposing a portion of said inner surface of said tubular cap;
installing said glove on a hand of a user;
applying an adhesive to a distal tip portion of said glove finger without applying said adhesive to a length of said glove finger
positioning said pocket of said tubular cap over said adhesive applied to said glove finger to adhere said inner surface within said pocket of said tubular cap to said glove finger, said positioning including initially unrolling said tubular cap to cover said adhesive on said glove finger without covering said length of said glove finger;
following said positioning operation, applying an additional portion of said adhesive to at least one of said length of said glove finger and said exposed portion of said inner surface of said tubular cap; and
unrolling said tubular cap down a length of said glove finger to adhere a remainder of said inner surface of said tubular cap to said length of said glove finger, wherein said applying, positioning, applying, and unrolling operations are performed while said glove is worn on said hand of said user.

16. A method as claimed in claim 15 further comprising abrading said glove finger with an abrasive material prior to applying said adhesive to said glove finger.

17. A method as claimed in claim 15 wherein:
said applying said additional portion of said adhesive comprises applying said additional portion of said adhesive to an intermediate section of said glove finger between said distal end and a proximal end of said glove finger without applying said adhesive to said proximal end of said glove finger;
said unrolling operation comprises performing said unrolling operation to cover said adhesive in said intermediate section said glove finger without covering a remainder of said length of said glove finger;
applying another portion of said adhesive to said proximal end of said glove finger; and
continuing said unrolling operation to cover said adhesive in said proximal section of said glove finger.

18. A method as claimed in claim 15 wherein said turning said tubular cap inside out causes a first portion of said outer surface of said tubular cap to fold back and face a second portion of said outer surface of said tubular cap, and said unrolling operation comprises:
sliding a rigid applicator between said first and second portions of said outer surface; and
utilizing said rigid applicator to apply pressure against said tubular cap at a fold junction between said first and second portions to unroll said tubular cap.

19. A method as claimed in claim 15 wherein said glove finger includes glove seams on opposing sides of said glove finger and aligned with said length of said glove finger, said tubular cap includes cap seams on opposing sides of said tubular cap and aligned with a length of said tubular cap, and said method further comprises aligning said cap seams with said glove seams.

20. A method as claimed in claim 15 further comprising compressing said tubular cap on said glove finger while said glove is worn on said hand of said user following said unrolling operation.
